(19) United States
(12) Patent Application Publication
(10) Pub. No.: US 2025/0083706 A1
(43) Pub. Date: Mar. 13, 2025

(54) Control Device and Method for Controlling an Operation of a Motor Vehicle

(71) Applicant: Bayerische Motoren Werke Aktiengesellschaft, Muenchen (DE)

(72) Inventor: Vladislav NENCHEV, Muenchen (DE)

(21) Appl. No.: 18/823,822

(22) Filed: Sep. 4, 2024

(30) Foreign Application Priority Data
Sep. 7, 2023 (DE) 10 2023 124 167.2

(51) Int. Cl. B60W 60/00

(52) U.S. Cl. CPC B60W 60/0016; B60W 60/0013; B60W 2520/00

(57) ABSTRACT

A control device is provided for controlling or regulating an operation of a motor vehicle. The control device is designed to determine a course of a first boundary based on a surroundings model of the motor vehicle and to determine a course of a second boundary based on the surroundings model. The first boundary delimits an area maximally traversable by the motor vehicle and the second boundary delimits a further area traversable by the motor vehicle, which is located completely within the area delimited by the first boundary and which the motor vehicle can leave for a predetermined period of time. The control device is designed to adapt the determined course of the second boundary in a section at the height of the motor vehicle so that the further area delimited by the second boundary is expanded in this section and decreases with increasing distance from the motor vehicle.

### CROSS REFERENCE TO RELATED APPLICATION

This application claims priority under 35 U.S.C. § 119 from German Patent Application No. DE 10 2023 124 167.2, filed Sep. 7, 2023, the entire disclosure of which is herein expressly incorporated by reference.

### BACKGROUND AND SUMMARY

The present disclosure relates to a control device or control unit for controlling an operation of a motor vehicle, a motor vehicle comprising the control device, and/or a (control) method for controlling operation of a motor vehicle. Additionally or alternatively, a computer program is provided which comprises commands that, upon the execution of the program by a computer, prompt it to at least partially carry out the method. Additionally or alternatively, a computer-readable medium is provided which comprises commands that, upon the execution of the commands by a computer, prompt it to at least partially carry out the method.

In modern motor vehicles, in particular automobiles, driver assistance systems are increasingly being installed. Driver assistance systems ((Advanced) Driver Assistance Systems, (A)DAS) are electronic, in particular mechatronic devices in motor vehicles to assist the driver in specific driving situations. Safety aspects are often in the foreground here, but increasing the driving comfort is as well. Driver assistance systems can carry out the movement planning and optionally, based thereon, the lateral control and/or longitudinal control of motor vehicles.

A trajectory or path planning can include comfort and safety limiting parameters. In the result of the planning, comfort limiting parameters can be infringed in the short term. In contrast, safety limiting parameters cannot be infringed. Comfort limiting parameters are usually defined significantly more strictly than safety limiting parameters. Safety limiting parameters can either correspond to the safe operating range or are a restricted subset thereof. The limiting parameters for a planning can be acquired directly from surroundings models. The surroundings model can be estimated based on sensor data which are acquired by means of onboard and/or offboard sensors. The surroundings model can then be used to predict future change in the surroundings of the motor vehicle. Based thereon, not only measured limits (in particular lane estimation and therefore, for example, a traversable road area) at the point in time t=0 can result, but also a predicted movement course for further vehicles in the surroundings of the motor vehicle for t>0 (i.e., in the future), from which limiting parameters for a planning can in turn also be created. For example, for the longitudinal movement of the motor vehicle, limits over time can result from the predicted movement profile of a leading vehicle.

Noises, as well as sporadically occurring larger jumps in the odometry (above all of the measured actual position) and the currently estimated course of a center line from the surroundings model can cause an infringement of the comfort limiting parameters in the first part of the trajectory/path planning, which can result in unsteady steering behavior in laterally-controlled driver assistance functions.

This problem can also occur in a longitudinal planning and can cause undesired braking jerks if, for example, the measured actual acceleration infringes comfort limiting parameters for an acceleration to be planned of a longitudinal planning or jumps occur in the object perception of the leading object and this infringes the comfort distance of the ego vehicle to a leading motor vehicle.

Against the background of this prior art, the object of the present disclosure is to specify a device and/or a method which are each suitable for enhancing the prior art.

The object is achieved by the features of the independent claims. The other independent claims and the dependent claims each have optional refinements of the disclosure as the content.

Accordingly, the object is achieved by a control device for controlling or regulating an operation of a motor vehicle, wherein the control device is designed to determine a course of a first boundary based on a surroundings model of the motor vehicle and to determine a course of a second boundary based on the surroundings model.

The first boundary delimits an area maximally traversable by the motor vehicle, and the second boundary delimits a further area traversable by the motor vehicle, which is located completely within the area delimited by the first boundary and which the motor vehicle can leave for a predetermined period of time.

The control device is designed to adapt the course of the determined second boundary in one section at the level of the motor vehicle so that the further area delimited by the second boundary is expanded in this section and decreases with increasing distance from the motor vehicle.

The control device or control unit can be part of a driver assistance system of the motor vehicle or can represent it. The control device can be, for example, an electronic control unit (ECU). The electronic control unit can be an intelligent processor-controlled unit, which can communicate, for example, via a central gateway (CGW) with other modules and which can optionally form the vehicle onboard network via field buses, such as the CAN bus, LIN bus, MOST bus, FlexRay, and/or via the automotive ethernet, for example, together with telematics controllers and/or a surroundings sensor system.

It is conceivable that the control device controls functions relevant for the driving behavior of the motor vehicle, such as the steering, the motor control, the force transmission, and/or the braking system. In addition, driver assistance systems, such as a parking assistant, and adaptive cruise control (ACC), a lane keeping assistant, a lane changing assistant, a traffic sign identification unit, a traffic signal identification unit, a starting assistant, a night view assistant, and/or an intersection assistant, can be controlled by the control device.

Insofar as the terms “controller” or a “control” or “controlling” are used in the present case, this is to be understood as a “controller or a regulator” or “a control or a regulation” or “controlling or regulating”, even if the latter is not explicitly mentioned. This also applies analogously to modified forms of the abovementioned terms.

A surroundings model can be understood as a model which comprises information with respect to static and/or dynamic objects located in the surroundings of the motor vehicle and/or about a roadway course.

The surroundings model can be generated by the control device. The motor vehicle can have a sensor system, by means of which sensor data are acquired, which in turn include or comprise the information on the basis of which the surroundings model is determined or created by the control device. Sensor data fusion can be used to create the surroundings model.

The first boundary can be information which comprises the safety limiting parameters described at the outset or consists thereof.

The second boundary can be information which comprises the comfort limiting parameters described at the outset or consists thereof.

The maximally traversable area can therefore be understood as an area which the motor vehicle is not permitted to leave.

The further area traversable by the motor vehicle, which is delimited by the second boundary, can therefore be understood as an area in which the motor vehicle is preferably to be located, but which can be left for the predetermined period of time.

The term area relates to a spatial area or a region around the motor vehicle. If the determined areas are to be used for automated lateral control of the motor vehicle, the two areas can be delimited laterally, i.e., to the left and/or right, by the respective boundary thereof viewed from the motor vehicle.

If the determined areas are used for automated longitudinal control of the motor vehicle, the two areas can be delimited in the travel direction, i.e., to the front and/or to the rear, by the respective boundary thereof viewed from the motor vehicle.

In both cases, the boundaries can specify not only a spatial area, but also a temporal range. In other words, the boundaries can specify not only where the motor vehicle is to be located, but rather also when it is to be located where.

It is furthermore conceivable that the areas are used for automated lateral and longitudinal control, wherein the above description then applies analogously.

The course can relate to an imaginary line in the surroundings model, which extends along an (outer) boundary of the above-described areas. In the case of the spatial delimitation, the course of the boundary therefore specifies a location of an outer contour of the respective (driving) area. The course can be defined, for example, by a function, such as a polynomial or a polynomial traverse or spline.

The above-described device offers an array of advantages. Among other things, it can be ensured that an infringement of comfort restrictions can be prevented due to their large selection in vehicle proximity even in the event of jumps or a sudden change of an actual position, actual travel direction, actual velocity, and/or actual acceleration (for example, because these were completely or partially measured) of the motor vehicle defining a starting state for a path or trajectory planning. Undesired steering corrections and jerky braking can therefore be minimized. However, it is still ensured that the safety restrictions are not infringed.

Possible refinements of the above-described device are explained in detail hereinafter.

The control device can be designed to adapt the course of the second boundary so that the further area delimited by the second boundary is maximally (large) at a beginning of a predefined planning horizon (in width and/or length, and/or temporally).

The planning horizon can be understood as a spatial area and/or temporal range for which the boundaries and therefore the areas are to be determined. In one example, this area can begin at the height of the motor vehicle and extend by a predefined number of meters in front of the motor vehicle. In another example, this area can begin at the height of the motor vehicle and extend by a predefined number of meters in front of the motor vehicle, which are covered within a predetermined period of time (such as 5 seconds) based on a current and/or planned velocity and/or acceleration of the motor vehicle. The area defining the planning horizon can also be spatially delimited laterally. It is also conceivable that the planning horizon is defined by the surroundings model or its boundaries. The above statements on the areas, the boundaries of which are determined, apply analogously to the planning horizon.

Because the second boundary can be selected to be maximally wide at the beginning of the planning horizon, at which jumps in actual state (see above) of the motor vehicle have particularly strong effects in the path or trajectory planning, the infringement of the second boundary or the comfort restrictions can be prevented with a high level of reliability.

The control device can be designed to determine a starting point, through which the second boundary extends, at the beginning of the planning horizon based on the course of the first boundary.

The control device can be designed to determine the starting point by subtracting a predetermined offset from a point, through which the first boundary extends at the beginning of the predefined planning horizon according to its determined course.

It is theoretically also conceivable that the offset is set to zero. That is to say, it is also conceivable that the comfort restriction at the beginning of the planning horizon corresponds to the safety restriction.

The first and/or the second boundary can delimit the maximally traversable area or the further traversable area laterally to the outside viewed from the motor vehicle.

As already described above, this is advantageous in the planning of the automated lateral control. The side or lateral delimitation can orient itself to a roadway course and to objects (such as further road users) in the surroundings model.

The control device can be designed to determine a length of the section in which the further area delimited by the second boundary is expanded at the height of the motor vehicle based on a velocity of the motor vehicle.

The length can correspond to an extension of the section along a direction of travel of the motor vehicle and/or along a motor vehicle longitudinal direction of the motor vehicle.

It is conceivable that the length of the section increases with rising velocity of the motor vehicle.

This offers the advantage that even at high velocities, at which the above-described jumps have a tendency to result more strongly, the infringement of the comfort restrictions can be prevented.

The control device can be designed to determine a path to be driven by the motor vehicle so that the motor vehicle progressing along the path is located at all times completely within the maximally traversable area that is delimited by the first boundary and leaves the area delimited by the second boundary at most for the predetermined period of time.

In addition, the control device can be designed to control or regulate a lateral and/or longitudinal control of the motor vehicle so that the motor vehicle progresses in an automated manner along the determined path.

A path can be understood as position information, that is to say where the motor vehicle is supposed to be located. The path can also have temporal information, that is to say when the motor vehicle is to be located where. In the latter case, the path is referred to as a trajectory.

The description above can be summarized in other words and in a possibly more specific embodiment of the disclosure as described hereinafter, wherein the following description is not to be interpreted as restrictive for the disclosure.

The comfort restrictions can be expanded in the first part of the planning horizon. At the point in time 0 of the planning, an initial maximum value can be defined for the comfort restrictions. This maximum value is less than or equal to the safety restrictions. The restrictions can then be interpolated via the center line to the front until they reach the desired stricter target comfort restrictions. The length of the area having expanded barriers can be velocity-dependent. It is conceivable that this area is longer at higher velocities and shorter at lower velocities.

The result is that, even in the event of jumps of the initial planning status (for example, because it was completely or partially measured), this does not infringe the comfort restrictions and can comfortably plan out the movement of the vehicle.

In some situations, it can be advantageous to also expand safety restrictions analogously. The expanded area can exceed the initially estimated hard safety boundaries in this case.

Furthermore, a motor vehicle having the above-described control unit or control device is provided.

The motor vehicle can be a passenger vehicle, in particular an automobile, and/or a utility vehicle, such as a truck.

The motor vehicle can be automated. The motor vehicle can be designed to at least partially and/or at least temporarily take over a longitudinal control and/or a lateral control by means of the control device during automated driving of the motor vehicle.

The automated driving can take place so that the progression of the motor vehicle takes place (substantially) autonomously. The automated driving can be at least partially and/or temporarily controlled by the control device.

It is conceivable that the motor vehicle intervenes in the lateral control of the motor vehicle by way of a driver assistance system actively, for example, by an adaptation of an actual steering wheel position, and optionally passively, for example, by a display of a turn direction. The same applies to the longitudinal control of the motor vehicle.

The motor vehicle can be a motor vehicle of autonomy level 0, i.e., the driver takes over the dynamic driving task even if assisting systems (such as ABS or ESP) are present.

The motor vehicle can be a motor vehicle of autonomy level 1, i.e., have specific driver assistance systems which assist the driver in the vehicle operation, such as adaptive cruise control (ACC) for example.

The motor vehicle can be a motor vehicle of autonomy level 2, i.e., partially automated so that functions such as automatic parking, lane keeping or lateral control, general longitudinal control, acceleration, and/or deceleration are taken over by driver assistance systems.

The motor vehicle can be a motor vehicle of autonomy level 3, i.e., conditionally automated so that the driver does not have to continuously monitor the system of the vehicle. The motor vehicle independently carries out functions such as triggering the turn signal, lane changing, and/or lane keeping. The driver can pursue other occupations but will be prompted by the system if needed within a prewarning time to take over the control.

The motor vehicle can be a motor vehicle of autonomy level 4, i.e., so highly automated that the control of the vehicle is permanently taken over by the system of the vehicle. If the driving tasks are no longer managed by the system, the driver can be prompted to take over the control.

The motor vehicle can be a motor vehicle of autonomy level 5, i.e., so fully automated that the driver is not necessary to fulfill the driving task. Except for defining the destination and starting the system, no human intervention is necessary. The motor vehicle can manage without steering wheel and pedals.

The description above with respect to the control device also applies analogously to the motor vehicle and vice versa.

Furthermore, a method for controlling an operation of a motor vehicle is provided, wherein the method comprises determining a course of a first boundary based on a surroundings model of the motor vehicle and determining a course of a second boundary based on the surroundings model. The first boundary delimits an area maximally traversable by the motor vehicle. The second boundary delimits a further area traversable by the motor vehicle, which is located completely within the area delimited by the first boundary and which the motor vehicle can leave for a predetermined period of time. The method comprises adapting the specific course of the second boundary in a section at the height of the motor vehicle, so that the further area delimited by the second boundary is expanded in this section and decreases with increasing distance from the motor vehicle.

The (control) method can be a computer-implemented method, i.e., one, several, or all steps of the method can be carried out at least partially by a computer or a device for data processing, optionally the control device.

The description above with respect to the control device and to the motor vehicle also applies analogously to the method and vice versa.

Furthermore, a computer program is provided, comprising commands which, upon the execution of the program by a computer, prompt it to at least partially execute or carry out the above-described method.

A program code of the computer program can be provided in any arbitrary code, in particular in a code which is suitable for controllers of motor vehicles.

The description above with respect to the control device, the motor vehicle, and the method also applies analogously to the computer program and vice versa.

Furthermore, a computer-readable medium is provided, in particular a computer-readable storage medium. The computer-readable medium comprises commands which, upon the execution of the commands by a computer, prompt it to at least partially execute or carry out the above-described method.

That is to say, a computer-readable medium can be provided which comprises an above-defined computer program. The computer-readable medium can be any desired digital data storage device, such as a USB stick, a hard drive, a CD-ROM, an SD card, or an SSD card (or SSD drive/SSD hard drive).

The computer program does not necessarily have to be stored on such a computer-readable storage medium in order to be provided to the motor vehicle, but rather can also be externally acquired via the Internet or in another way.

The description above with respect to the method, the control device, the computer program, and the motor vehicle also applies analogously to the computer-readable medium and vice versa.

An optional embodiment is described hereinafter with reference to FIGS. 1 to 3

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows a motor vehicle having a control device according to the disclosure,

FIG. 2 shows the motor vehicle in a possible driving situation in which a method according to the disclosure can be applied, and

FIG. 3 schematically shows a flow chart of the method according to the disclosure for controlling an operation of the motor vehicle.

### DETAILED DESCRIPTION OF THE DRAWINGS

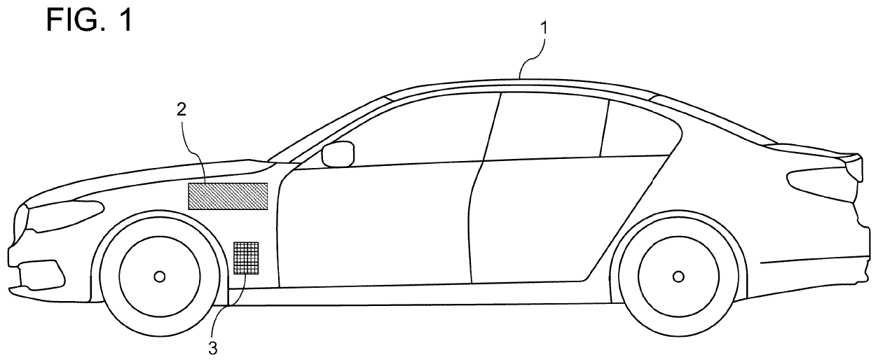

The motor vehicle 1, which is only shown schematically in FIG. 1, has a control device 2 according to the disclosure and a sensor system 3 connected thereto.

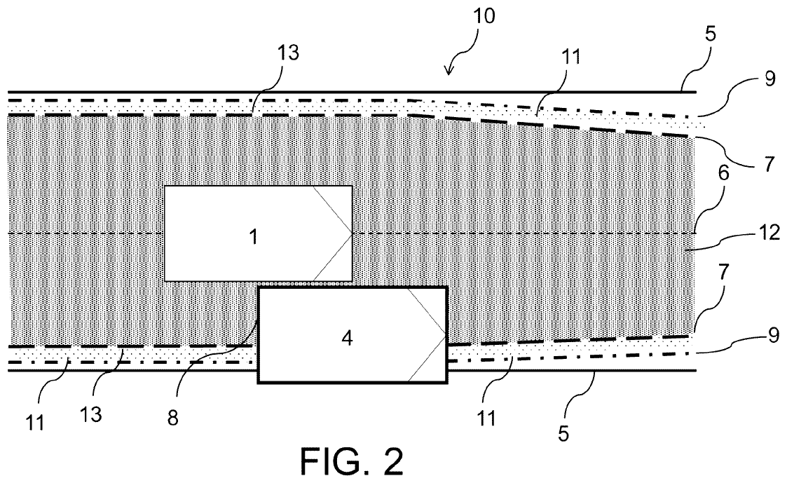

In FIG. 2, the motor vehicle 1 is shown in a top view (BEV=bird's eye view) according to a surroundings model 10. The motor vehicle 1 is located on a roadway 5 having a center line 6, wherein a further motor vehicle 4 merges onto the roadway 5 in front of the motor vehicle 1 in the direction of travel (from left to right in FIG. 2). This driving situation is used as an example for the following description of the method 100 according to the disclosure.

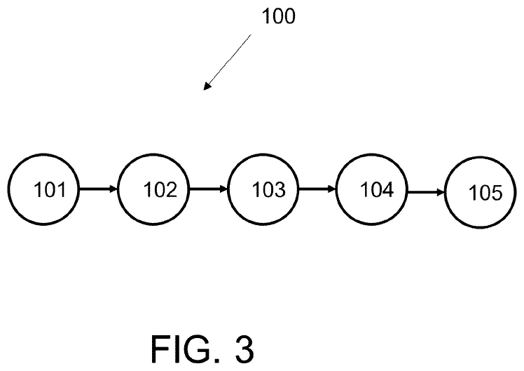

The control device 2 of the motor vehicle 1 is designed to execute the (control) method 100, which is also described hereinafter in detail with reference to FIG. 3.

In a first step 101 of the method 100, the control device 2 determines the surroundings model 10 of the motor vehicle 1 (the top view of which is shown in FIG. 2, see above) based on surroundings information received from the sensor system 3 in the form of sensor data.

In a second step 102 of the method 100, the control device 2 determines a course of a first hard boundary 9 based on the surroundings model 10 of the motor vehicle 1 determined in the first step S1. This is a so-called safety restriction, which cannot be exceeded or driven over by the motor vehicle 1 in the further course of the journey.

In the present case, this first hard boundary 9 initially extends, viewed in the direction of travel, parallel to the lateral edges of the roadway 5 and then bends inward toward the center line 6 after passing the motor vehicle 1. The course of the first hard boundary 9 is selected having a predetermined safety distance to the respective edge 5, so that the motor vehicle 1 leaving the roadway 5 can be avoided with sufficiently high probability and therefore reliably. The further motor vehicle 4 contained in the surroundings model 10, more precisely its outer boundary or contour, represents a second hard boundary 8, the course of which is also determined by the control device 2. The first and the second hard boundaries 8, 9 therefore define an area 11 maximally traversable by the motor vehicle 1 or laterally delimit it in the present case viewed from the motor vehicle 1. A trajectory planning therefore has to take place, which avoids the motor vehicle 1 driving over these two hard boundaries 8, 9.

In a third step 103 of the method 100, the control device 2 of the motor vehicle 1 determines a course of a soft boundary 7 based on the surroundings model 10.

The soft boundary 7 is a so-called comfort restriction and in the present case delimits a further area 12 traversable by the motor vehicle 1. This further area 12 is located completely within the area 11 delimited by the two hard boundaries 8, 9 and can be left by the motor vehicle 1 for a predetermined period of time.

The further area 12 delimited by the second boundary is maximal at a beginning of a predefined planning horizon, here the rear end in the direction of travel or left end in FIG. 3 of the surroundings model 10. A starting point, through which the soft boundary 7 extends, is determined at the beginning of the planning horizon based on the course of the first hard boundary 9. More precisely, the control device 2 determines the starting point by subtracting a predetermined offset from a point through which the first hard boundary 9 extends at the beginning of the predefined planning horizon according to its determined course.

Proceeding from this starting point, the soft boundary 7 extends in a first section 13 in the direction of travel of the motor vehicle 1 parallel to the first hard boundary 9, corresponds to the second hard boundary 8 formed by the further motor vehicle 4, and bends inward in the direction of the center line 6 like the first hard boundary 9 (not an error, but the second boundary has a lower number than the first) in the further course after passing the motor vehicle 1.

The course of the soft boundary 7 determined by the control device 2 is accordingly adapted or selected by the control device 2 in the section 13 at the height of the motor vehicle 1 so that the further area 12 delimited by the soft boundary 7 is expanded in the section 13 and thus at the height of the motor vehicle 1 and decreases or tapers in the top view with increasing distance from the motor vehicle 1 in the direction of travel of the motor vehicle 1.

The length of the section 13, in particular the excess beyond the motor vehicle 1 in the direction of travel of the motor vehicle 1, in which the further area delimited by the second boundary is expanded at the height of the motor vehicle, is determined by the control device 2 based on a velocity of the motor vehicle 1.

In a fourth step 104 of the method 100, the control device 2 determines a path to be driven by the motor vehicle 1 so that the motor vehicle 1 progressing along the path is located at all times completely within the maximally traversable area 11 delimited by the hard boundaries 8, 9 and leaves the area 12 delimited by the soft boundary 7 at most for the predetermined (i.e., permissible) period of time. In the present case, the determined path can correspond to the center line 6.

In a fifth step 105 of the method 100, the control device 2 controls or regulates a lateral and/or longitudinal control of the motor vehicle 1 so that the motor vehicle 1 progresses in an automated manner along the determined path, the center line 6 here.

The above-described method 100 is carried out continuously by the control device 2 in order to drive the motor vehicle 1 in an automated manner.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A control device for controlling or regulating an operation of a motor vehicle, wherein the control device is designed to:
determine a course of a first boundary based on a surroundings model of the motor vehicle, and
determine a course of a second boundary based on the surroundings model,
wherein the first boundary delimits an area maximally traversable by the motor vehicle, and
wherein the second boundary delimits a further area traversable by the motor vehicle, which is located completely within the area delimited by the first boundary and which the motor vehicle can leave for a predetermined period of time,
wherein the control device is designed to adapt the determined course of the second boundary in a section at a height of the motor vehicle so that the further area delimited by the second boundary is expanded in the section and decreases with increasing distance from the motor vehicle.

2. The control device according to claim 1, wherein the control device is designed to adapt the course of the second boundary so that the further area delimited by the second boundary is maximal at a beginning of a predefined planning horizon.

3. The control device according to claim 2, wherein the control device is designed to determine a starting point, through which the second boundary extends, at the beginning of the planning horizon based on the course of the first boundary.

4. The control device according to claim 3, wherein the control device is designed to determine the starting point by subtracting a predetermined offset from a point through which the first boundary extends at the beginning of the predefined planning horizon according to its determined course.

5. The control device according to claim 1, wherein the control device is designed to determine a length of the section, in which the further area delimited by the second boundary is expanded at the height of the motor vehicle, based on a velocity of the motor vehicle.

6. The control device according to claim 2, wherein the control device is designed to determine a length of the section, in which the further area delimited by the second boundary is expanded at the height of the motor vehicle, based on a velocity of the motor vehicle.

7. The control device according to claim 3, wherein the control device is designed to determine a length of the section, in which the further area delimited by the second boundary is expanded at the height of the motor vehicle, based on a velocity of the motor vehicle.

8. The control device according to claim 4, wherein the control device is designed to determine a length of the section, in which the further area delimited by the second boundary is expanded at the height of the motor vehicle, based on a velocity of the motor vehicle.

9. The control device according to claim 1, wherein the control device is designed to:
determine a path to be driven by the motor vehicle so that the motor vehicle progressing along the path is located at all times completely within the maximally traversable area that is delimited by the first boundary and leaves the area delimited by the second boundary at most for the predetermined period of time, and
control or regulate a lateral and/or longitudinal control of the motor vehicle so that the motor vehicle progresses in an automated manner along the determined path.

10. The control device according to claim 2, wherein the control device is designed to:
determine a path to be driven by the motor vehicle so that the motor vehicle progressing along the path is located at all times completely within the maximally traversable area that is delimited by the first boundary and leaves the area delimited by the second boundary at most for the predetermined period of time, and
control or regulate a lateral and/or longitudinal control of the motor vehicle so that the motor vehicle progresses in an automated manner along the determined path.

11. The control device according to claim 3, wherein the control device is designed to:
determine a path to be driven by the motor vehicle so that the motor vehicle progressing along the path is located at all times completely within the maximally traversable area that is delimited by the first boundary and leaves the area delimited by the second boundary at most for the predetermined period of time, and
control or regulate a lateral and/or longitudinal control of the motor vehicle so that the motor vehicle progresses in an automated manner along the determined path.

12. The control device according to claim 4, wherein the control device is designed to:
determine a path to be driven by the motor vehicle so that the motor vehicle progressing along the path is located at all times completely within the maximally traversable area that is delimited by the first boundary and leaves the area delimited by the second boundary at most for the predetermined period of time, and
control or regulate a lateral and/or longitudinal control of the motor vehicle so that the motor vehicle progresses in an automated manner along the determined path.

13. The control device according to claim 5, wherein the control device is designed to:
determine a path to be driven by the motor vehicle so that the motor vehicle progressing along the path is located at all times completely within the maximally traversable area that is delimited by the first boundary and leaves the area delimited by the second boundary at most for the predetermined period of time, and
control or regulate a lateral and/or longitudinal control of the motor vehicle so that the motor vehicle progresses in an automated manner along the determined path.

14. A motor vehicle including a control device according to claim 1.

15. A method for controlling an operation of a motor vehicle, the method comprising:
determining a course of a first boundary based on a surroundings model of the motor vehicle;
determining a course of a second boundary based on the surroundings model;
wherein the first boundary delimits an area maximally traversable by the motor vehicle, and
wherein the second boundary delimits a further area traversable by the motor vehicle, which is located completely within the area delimited by the first boundary and which the motor vehicle can leave for a predetermined period of time; and
adapting the determined course of the second boundary in a section at the height of the motor vehicle, so that the further area delimited by the second boundary is expanded in this section and decreases with increasing distance from the motor vehicle.

16. A non-transitory computer-readable medium storing a program including commands which, upon execution of the program by a computer, causes the computer to carry out a method according to claim 15.
